(19) United States
(12) Patent Application Publication
(10) Pub. No.: US 2019/0187253 A1
(43) Pub. Date: Jun. 20, 2019

(54) SYSTEMS AND METHODS FOR IMPROVING LIDAR OUTPUT

(71) Applicant: Vathys, Inc., Portland, OR (US)

(72) Inventor: Tapabrata GHOSH, Portland, OR (US)

(21) Appl. No.: 16/220,450

(22) Filed: Dec. 14, 2018

Related U.S. Application Data
(60) Provisional application No. 62/598,998, filed on Dec. 14, 2017.

(51) Int. Cl. G01S 7/48; G06N 3/08; G01S 17/93; G01S 17/08

(52) U.S. Cl. CPC G01S 7/4808; G01S 17/08; G01S 17/936; G06N 3/08

(57) ABSTRACT

Light Detection and Ranging (LIDAR) is playing an increasingly important role in autonomous systems, including autonomous vehicles. However, the cost of LIDAR systems and low output quality (e.g., resolution, accuracy and/or smoothness) are factors limiting the adoption and utility of LIDAR systems. Disclosed are methods and devices to use machine learning models to increase the quality of the output of a LIDAR system.

### CROSS-REFERENCE TO RELATED APPLICATIONS

This application claims the benefit of priority of U.S. Provisional Application No. 62/598,998 filed on Dec. 14, 2017 entitled “A Method of Producing High Quality LIDAR Outputs,” content of which is incorporated herein by reference in its entirety and should be considered a part of this specification.

### BACKGROUND

### Field of the Invention

This invention relates generally to the field of Light Imaging Detection and Ranging or Light Detecting and Ranging Systems, commonly referred to as “LIDAR,” and more particularly to methods and devices for improving the output of LIDAR systems, for example, those used in the automotive industry.

### Description of the Related Art

Higher quality LIDAR output (e.g., higher resolution, higher accuracy, and/or other improved metrics or qualities) is generally desirable in many systems. Existing LIDAR systems have primarily focused on improving output by improving data collection capabilities and hardware features. Examples include, mechanical LIDARs and LIDARs sold primarily by Velodyne of San Jose, Calif. (Phone: 669-275-2251). Other existing LIDAR technologies include, optical phased arrays, mirror galvanometer driven LIDARs, flash LIDARs and MEMS LIDARs. Consequently, there is a need for LIDAR systems with improved hardware and software capability to collect and output LIDAR data.

### SUMMARY

In one aspect of the invention, a method of producing an output in a LIDAR system is disclosed. The method includes: emitting light toward a target, wherein the emitted light comprises a first dataset; sensing a reflected light from the target, wherein the reflected light comprises a second dataset; performing machine learning operations on the first and second datasets to produce a first output, wherein the first output comprises distance information relative to the target.

In one embodiment, the output of the LIDAR system comprises the first output.

In another embodiment, the first output comprises a point cloud, machine learning comprises one or more neural networks and the machine learning operations comprise increasing resolution of the point cloud.

In some embodiments, the neural networks comprise one or more of convolutional neural network, generative adversarial network, and variational autoencoder.

In one embodiment, sensing the reflected light comprises detecting light with a SPAD array.

In another embodiment, the method further includes performing second machine learning operations on the first output to produce a second output, wherein the second output comprises distance information relative to the target.

In one embodiment, the output of the LIDAR system comprises the second output.

In some embodiments, machine learning comprises one or more neural networks, the first machine learning operation comprises generating a point cloud and the second machine learning operation comprises refining resolution of the point cloud.

In one embodiment, sensing the reflected light comprises detecting light with a SPAD array.

In one embodiment, the method further includes training one or more machine learning models to improve one or more characteristics of the first output.

In another aspect of the invention a LIDAR system is disclosed. The system includes: a light emitter source configured to emit light toward a target, wherein the emitted light comprises a first dataset; a light detector sensor configured to sense reflected light from the target, wherein the reflected light comprises a second dataset; a machine learning processor configured to perform machine learning operations on the first and second datasets to produce a first output, wherein the first output comprises distance information relative to the target.

In one embodiment, an output of the LIDAR system comprises the first output.

In some embodiments, the first output comprises a point cloud, the machine learning comprises one or more neural networks and the machine learning operations comprise increasing resolution of the point cloud.

In another embodiment, the neural networks comprise one or more of convolutional neural network, generative adversarial network, and variational autoencoder.

In one embodiment, the light detector sensor comprises a SPAD array.

In some embodiments, the machine learning processor is further configured to perform second machine learning operations to produce a second output, wherein the second output comprises distance information relative to the target.

In one embodiment, an output of the LIDAR system comprises the second output.

In some embodiments, machine learning comprises one or more neural networks, the first machine learning operations comprise generating a point cloud and the second machine learning operations comprise refining resolution of the point cloud.

In one embodiment, the light detector sensor comprises a SPAD array.

In some embodiments, the machine learning processor is further configured to train one or more machine learning models.

### BRIEF DESCRIPTION OF THE DRAWINGS

These drawings and the associated description herein are provided to illustrate specific embodiments of the invention and are not intended to be limiting.

FIG. 1 illustrates an example of a LIDAR system according to an embodiment.

FIG. 2 illustrates an example LIDAR data processing flow according to an embodiment.

FIG. 3 illustrates an example application of the disclosed LIDAR system and data processing.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

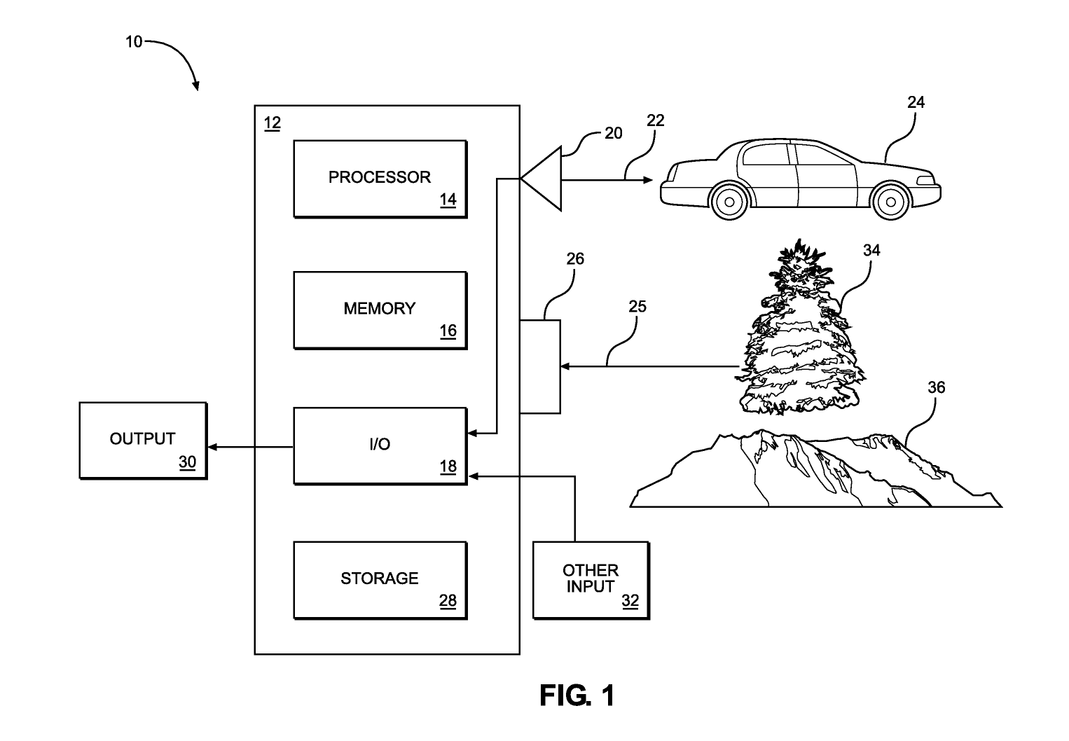

LIDAR systems measure distance by illuminating a target with a light source and detecting the reflected light. FIG. 1 illustrates a block diagram of a LIDAR system 10 according to an embodiment. The LIDAR system 10 can be implemented in a vehicle, an airplane, a helicopter, or other vessel where depth maps can be used to perform passive terrain surveys or used to augment a driver/operator ability or used in autonomous operation of the vessel, for example in a self-driving vehicle. The LIDAR system 10 can include a processor 14, a memory 16, input/output devices/interfaces 18 and storage 28. The LIDAR system 10 can include an emitter 20 transmitting light waves 22 toward one or more targets 24, 34, 36. The emitted light waves 22 will reflect back from the targets 24, 34, 36 and are detected by a sensor 26. Emitter 22 and 26 can illuminate light toward targets within a 3D space surrounding of the LIDAR system 10. In other words, the targets 24, 34 and 36 can be in range, whether behind, below, above or in front of a vessel 12 deploying the LIDAR system 10.

In one embodiment, the emitter 20 can include a laser transmitter configured to generate rapid pulses of laser (e.g., up to 150,000 pulses per second). In some embodiments, the emitter 20 can include an infrared transmitter diode; however, the wavelength of the light emitted can depend on the application and/or the environment where the LIDAR system 10 is to be deployed (e.g., whether water is present in the environment). Emitter 20 can utilize MEMs devices, rotating mirrors or micro motors to guide, transmit and emit light waves 22. Emitter 20 can also include controllers, processors, memory, storage or other features to control the operations of the emitter 20. The emitter 20 and associated controllers generate a transmitted light dataset, which can include data regarding the transmitted light waves 22, such as timing, frequency, wavelength, intensity, and/or other data concerning the circumstances and environment of transmitted light waves 22.

The transmitted light dataset can include data such as Global Positioning Signal data (GPS) (e.g., GPS coordinates) of the emitter 20, orientation of the emitter 20, accelerometer data, speedometer data, inertial guidance/measurement system data, gyroscope data, gyrocompasses data and/or other associated data.

The described components and functions are example implementations. Persons of ordinary skill in the art can envision alternative LIDAR systems, without departing from the described technology. For example, some components can be combined and/or some functionality can be performed and implemented elsewhere in the alternative system compared to those described in the LIDAR system 10. Some functionality can be implemented in hardware and/or software.

The processor 14 can be a machine learning processor optimized to handle machine learning operations, such as matrix manipulation. In one embodiment, to optimize processor 14 for machine learning, some and/or all components of memory 16 and/or I/O 18 can be made as integral components of the processor 14. For example, processor 14, memory 16 and/or I/O 18 can be implemented as a single multilayered IC. In other embodiments, a graphical processing unit (GPU) can be utilized to implement the processor 14.

The sensor 26 can include a photo diode receiver. In some embodiments, the sensor 26 can include a detector built with Single Photon Avalanche Diode (SPAD) arrays. Similar to emitter 20, the sensor 26 can include processors, controllers, memory, storage and software/hardware to receive raw photo detector data (e.g., voltages/currents) associated with reflected light waves 25 and generate a reflected light dataset, which can include data associated with the received reflected light, for example, time stamp, wave length, frequency, intensity and/or other relevant data.

The reflected light dataset can include data, such as Global Positioning Signal data (GPS) (e.g., GPS coordinates) of the sensor 26, orientation of the sensor 26, accelerometer data, speedometer data, inertial guidance/measurement system data, gyroscope data, gyrocompasses data and/or other associated data.

The transmitted and reflected light datasets can be routed and inputted to the processor 14 via an I/O device/interface 18. The processor 14 can perform non-machine learning operations, machine learning operations, pre-processing, post-processing and/or other data operations to output an intermediate and/or final LIDAR system output 30 using instructions stored on the storage 28. The LIDAR output 30 can include a depth map and/or a LIDAR point cloud, and/or other data structures which can be used to interpret distance or depth information relative to the targets 24, 34, 36. LIDAR output 30 can be used for object detection, feature detection, classification, terrain mapping, topographic mapping and/or other 3D vision applications. A LIDAR point cloud can be a data structure mapping GPS coordinates surrounding the LIDAR system 10 to one or more datasets. An output of the LIDAR system 10, such as a point cloud can be utilized to determine distance. While not the subject of the present disclosure, other components of vessel 12 may exist and can utilize the LIDAR output 30 for various purposes, for example for objection detection and/or for performing machine learning to implement self-driving algorithms.

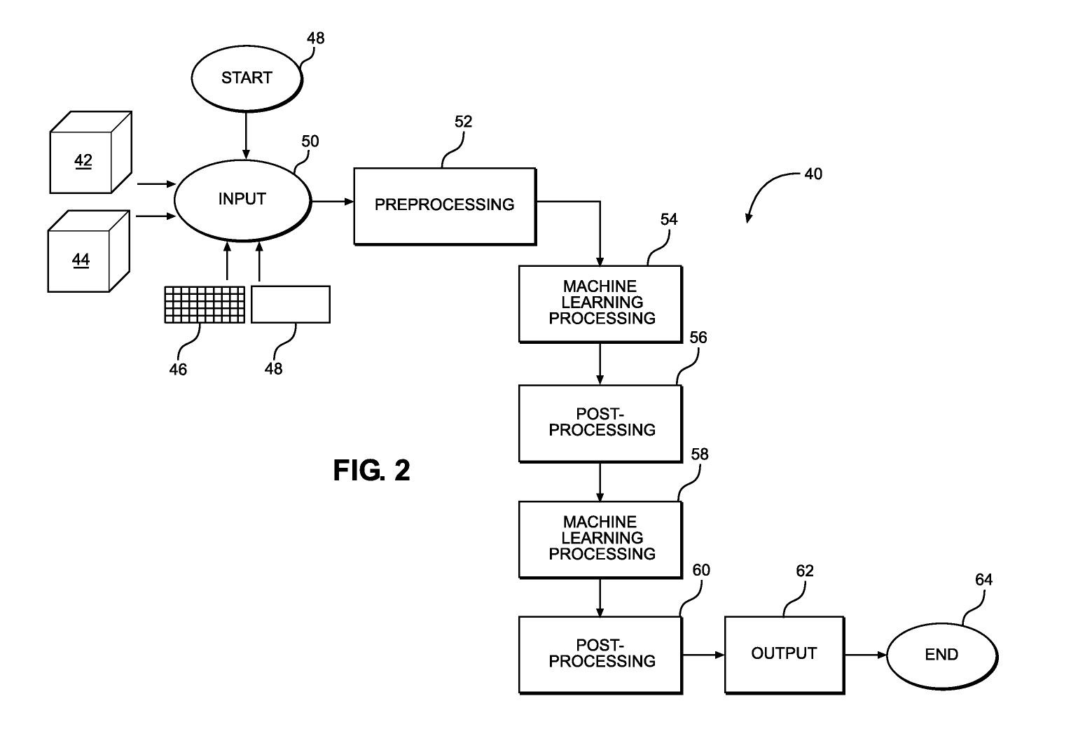

FIG. 2 illustrates an example LIDAR data processing flow 40 according to an embodiment. Processor 14 can be configured to perform the process 40. The process 40 starts at the step 48. At the step 50, LIDAR input data 42, 44, 46 and 48 are received. The input data 42 can include the transmitted light dataset, input data 44 can include reflected light dataset, input data 46 and 48 can include other sensor and/or gathered data, such as GPS data, inertial system measurement data, sensor orientation data, accelerometer data, speedometer data, gyroscope data, gyrocompass data, etc. The LIDAR input data can include single or multi-dimensional data, mappings between LIDAR input data, tables, registers, 2D or 3D models, stored terrain data, object classification and categorization data and/or related data.

The process 40 then moves to the step 52 where preprocessing operations are performed. Examples of preprocessing operations include performing low level signal processing operations such as Fast Fourier Transform (FFT), filtering, and/or normalization. The process 40 then moves to the step 54, where one or more machine learning model processing are used to process the LIDAR input data. Example machine learning models/operations which can be used include, neural networks, convolutional neural networks (CNNs), generative adversarial networks, variational autoencoder, and/or other machine learning techniques. The process 40 then moves to the step 56, where post-processing operations can be performed. Post-processing operations can include similar operations to the pre-processing operations performed at the step 52 or can include other signal processing operations such as domain conversion/transformation, optimization, detection and/or labeling. In other embodiments, the post-processing step 56 can include operations to generate an output data structure suitable for machines, devices and/or processors intended to receive and act on the output of the LIDAR system 10.

The process 40 then moves to the step 58 where further machine learning processing is performed. The machine learning operations of the step 58 can be similar to the machine learning processes of the step 54 or can include different classes of machine learning operations. The process 40 then moves to the step 60 where further post-processing operations can be performed on the resulting data. The process 40 then moves to the step 62 where LIDAR output is generated. The process 40 then ends at the step 64.

In some embodiments, the pre-processing step 52, and the post-processing steps 56 and 60 can be optional. One and not the others can be performed. In some embodiments, the second machine learning processing 58 can be optional. In one embodiment, an intermediate LIDAR output data structure maybe extracted from the process 40 after the machine learning processing 54 and inputted into other systems and/or devices which can utilize the intermediate output of a LIDAR system. In one embodiment, the intermediate LIDAR system output contains a data structure (e.g., a point cloud from which a depth or distance map can be extracted). In some embodiments, the machine learning processing steps 54 and 58 can be configured to increase accuracy, resolution, smoothness and/or other desired characteristics of an intermediate and/or final output of a LIDAR system (e.g., a point cloud).

In other embodiments, the first machine learning processing step 54 may be optional and the second machine learning step 58 may be performed instead. In some embodiments, desired output thresholds and tolerances can be defined and the process 40 and/or parts of it can be performed in iterations and/or loops until the desired thresholds and/or tolerances in the output are met. For example, while the process 40 is illustrated with performance of two machine learning steps 54 and 58, fewer or more machine learning processes may be introduced to achieve a desired characteristic in the output. For example, a desired resolution in a LIDAR output point cloud may be achieved by performing one set of machine learning processes, such as those performed in the step 54. In other scenarios, more than two or three instances of machine learning processes on the LIDAR input data may be performed to achieve a desired smoothness in the output point cloud. In autonomous vehicle applications where processing large amounts of LIDAR input in a time efficient manner is desired, an intermediate LIDAR output can be extracted after performing one machine learning process (e.g., machine learning processing of the step 54) to guide the autonomous driver algorithms in a timely manner.

The machine learning processes 54 and/or 58 can be trained to improve their performance. For example, if a neural network model is used, it can be trained using backpropagation to optimize the model. In the context of LIDAR output, training machine learning models can further improve the desired characteristics in the LIDAR output.

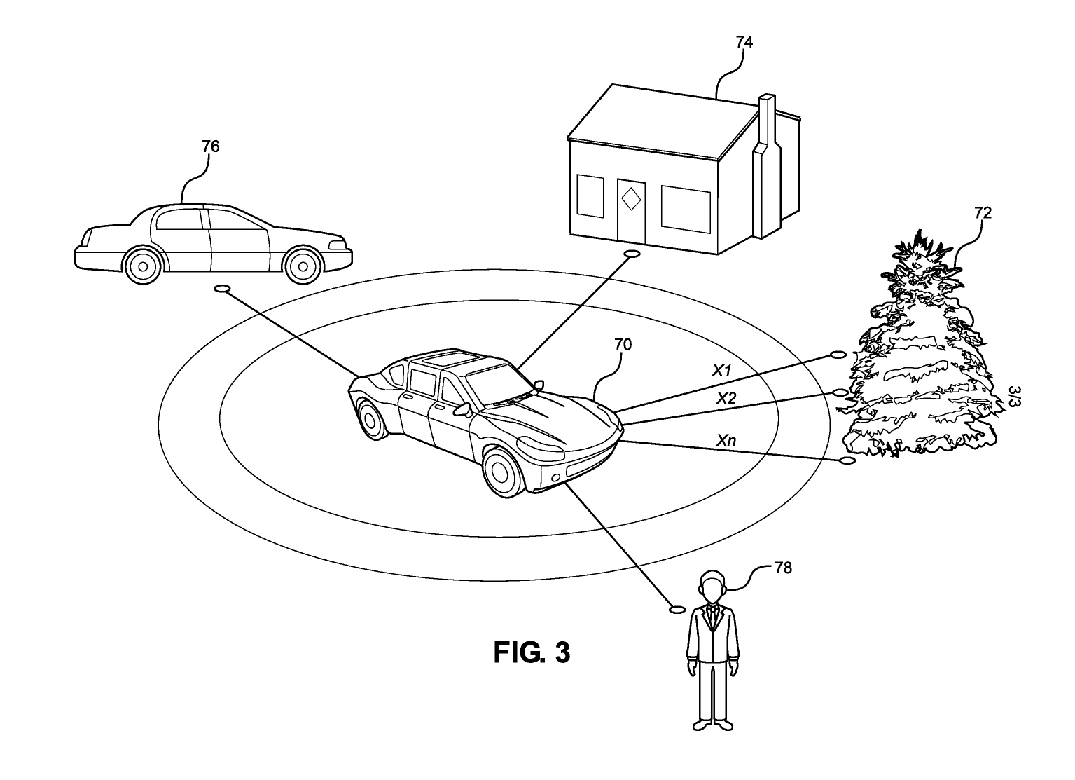

FIG. 3 illustrates an example application of the disclosed LIDAR system and data processing. Vehicle 70, which can be an autonomous (e.g., a self-driving vehicle) is outfitted with the LIDAR system 10. Targets 72, 74, 76 and 78 are in range. The transmitted light dataset includes a time stamp t1 of transmitted light waves sent toward target 72. The reflected light dataset includes a time stamp t2 of the received light waves from target 72. Distance D to target 72 can be determined by

$$D = \frac{c ( t 2 - t 1 )}{2} \qquad ( Eq . 1 )$$

where c is the speed of light and (t2−t1) is the time of flight. Several points from the surface of the object 72 can reflect light back toward the LIDAR system 10 and thus several distances such as x1, x2, . . . , xn and so forth can relate to the object 72. Other distances from other objects, for example, distances from objects 74, 76 and 78 can be received at the LIDAR system 10, where a 3D point cloud of these distances can be generated. Each object may yield hundreds or thousands of distances depending on their size, surface shape and other factors. Nonetheless, the machine learning operations 54 and/or 58 can be used to extrapolate additional distances related to the objects 72, 74, 76 and 78 and augment any intermediate and/or final 3D point cloud or depth map with machine learning model driven distances, thus increasing the resolution, accuracy and smoothness of output point clouds.

In another embodiment, the LIDAR system 10 can alternatively be implemented to use frequency modulated continuous-wave (FMCW) LIDAR. In one implementation, a transmitter can be configured to emit a continuous wave toward various targets surrounding the LIDAR system 10 and vary its frequency. A detector can receive reflected waves and measure the frequency of the received reflected waves. When a wave with a previously sent frequency is detected, its return time can help determine a distance to an object from which the wave was reflected. Other LIDAR techniques, associated sensors/detectors and their collected datasets can also be used. The raw data of an FMCW transmitter and detector, or if other sensor/detector is used in alternative LIDARs, their associated raw sensor/detector data can be used as inputs 42 and 44 in the process 40. Machine learning processing 54 and/or 58 can generate a LIDAR output (e.g., a point cloud) based on the datasets associated with transmitter/detector of an FMCW LIDAR, or other sensor/detector datasets when alternative LIDAR systems are used.

The machine learning operations 54 and/or 58 can improve a LIDAR output before it is outputted. For example, the machine learning operations 54 and/or 58 can denoise raw LIDAR detector data using neural networks before generating a point cloud based on that data. In another embodiment, the machine learning operations 54 and/or 58 can increase the resolution of the LIDAR output (e.g., a point cloud) before the output is sent to other machine learning processes that may be present within the vehicle 70.

The vehicle 70 can include other components, processors, computers and/or devices which may receive the output of the LIDAR system 10 (e.g., a point cloud) and perform various machine learning operations as may be known by persons of ordinary skill in the art in order to carry out various functions of the vehicle 70 (e.g., various functions relating to self-driving). Such machine learning processes performed elsewhere in various systems of vehicle 70 may be related, unrelated, linked or not linked to the machine learning processes performed in the LIDAR system 10 and the embodiments described above. In some cases, machine learning processes performed elsewhere in the vehicle 70 may receive as their input an intermediate and/or final output of the LIDAR system 10 as generated according to the described embodiments and equivalents thereof. In this scenario, the improved LIDAR outputs generated according to the described embodiments can help components of vehicle 70, which receive the improved LIDAR output, to more efficiently perform their functions.

The described machine learning techniques are intended as examples. Alternative machine learning models can be used, without departing from the spirit of the disclosed technology. For example, the 3D space surrounding the LIDAR system 10 can be compartmentalized and/or transformed into 2D space, where image processing machine learning models can be applied. In other instances, the 2D machine learning models can be modified to apply to a 3D space.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first, second, other and another and the like may be used solely to distinguish one entity or action from another without necessarily requiring or implying any actual such relationship or order between such entities or actions.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method of producing an output in a LIDAR system, comprising:
emitting light toward a target, wherein the emitted light comprises a first dataset;
sensing a reflected light from the target, wherein the reflected light comprises a second dataset;
performing machine learning operations on the first and second datasets to produce a first output, wherein the first output comprises distance information relative to the target.

2. The method of claim 1, wherein the output of the LIDAR system comprises the first output.

3. The method of claim 2, wherein the first output comprises a point cloud, machine learning comprises one or more neural networks and the machine learning operations comprise increasing resolution of the point cloud.

4. The method of claim 3, wherein the neural networks comprise one or more of convolutional neural network, generative adversarial network, and variational autoencoder.

5. The method of claim 1, wherein sensing the reflected light comprises detecting light with a SPAD array.

6. The method of claim 1 further comprising performing second machine learning operations on the first output to produce a second output, wherein the second output comprises distance information relative to the target.

7. The method of claim 6, wherein the output of the LIDAR system comprises the second output.

8. The method of claim 7, wherein machine learning comprises one or more neural networks, the first machine learning operation comprises generating a point cloud and the second machine learning operation comprises refining resolution of the point cloud.

9. The method of claim 8, wherein sensing the reflected light comprises detecting light with a SPAD array.

10. The method of claim 1 further comprising training one or more machine learning models to improve one or more characteristics of the first output.

11. A LIDAR system comprising:
a light emitter source configured to emit light toward a target, wherein the emitted light comprises a first dataset;
a light detector sensor configured to sense reflected light from the target, wherein the reflected light comprises a second dataset;
a machine learning processor configured to perform machine learning operations on the first and second datasets to produce a first output, wherein the first output comprises distance information relative to the target.

12. The system of claim 11 wherein an output of the LIDAR system comprises the first output.

13. The system of claim 12, wherein the first output comprises a point cloud, the machine learning comprises one or more neural networks and the machine learning operations comprise increasing resolution of the point cloud.

14. The system of claim 13, wherein the neural networks comprise one or more of convolutional neural network, generative adversarial network, and variational autoencoder.

15. The system of claim 11, wherein the light detector sensor comprises a SPAD array.

16. The system of claim 11, wherein the machine learning processor is further configured to perform second machine learning operations to produce a second output, wherein the second output comprises distance information relative to the target.

17. The system of claim 16, wherein an output of the LIDAR system comprises the second output.

18. The system of claim 17, wherein machine learning comprises one or more neural networks, the first machine learning operations comprise generating a point cloud and the second machine learning operations comprise refining resolution of the point cloud.

19. The system of claim 18, wherein the light detector sensor comprises a SPAD array.

20. The system of claim 18, wherein the machine learning processor is further configured to train one or more machine learning models.
